(19) United States
(12) Patent Application Publication
(10) Pub. No.: US 2006/0122906 A1
(43) Pub. Date: Jun. 8, 2006

(54) Distribution and collection surrogate system in internet on-line sale

(75) Inventor: Yoshiyuki Emi, Osaka-shi (JP)

Correspondence Address: HAMRE, SCHUMANN, MUELLER & LARSON, P.C., P.O. BOX 2902-0902, MINNEAPOLIS, MN, 55402, US

(73) Assignee: Toa Musendenki Co., Ltd., Osaka-shi (JP)

(21) Appl. No.: 11/328,604

(22) Filed: Jan. 10, 2006

Related U.S. Application Data
(63) Continuation of application No. 09/803,262, filed on Mar. 9, 2001, now abandoned.

(30) Foreign Application Priority Data
Mar. 10, 2000 (JP) 2000-066702

(51) Int. Cl. G06Q 30/00

(52) U.S. Cl. 705/26

(57) ABSTRACT

A delivery and collection proxy system in Internet on-line sales. The system includes: item information showing part for showing information about many items sold by a lot of stores on the Internet; order receiving part for receiving an order on the Internet for the items whose information is showed by the item information showing part while designating stores selling the items; order notifying part for notifying information about the order received by the order receiving part to a delivery liaison company dealing with the stores designated in the order via a communication line; and document data sending part for sending data to be written in documents required to be sent to an buyer in the name of a management company via a communication line to the delivery liaison company.

This application is a continuation of application Ser. No. 09/308,262, filed Mar. 9, 2001, entitled DISTRIBUTION AND COLLECTION SURROGATE SYSTEM IN INTERNET ON-LINE SALE, which is incorporated herein by reference.

This application is based upon application No. 2000-66702 filed in Japan, the contents of which are hereby incorporated by reference.

### BACKGROUND OF THE INVENTION

1. Field of the Invention

The present invention relates to a distribution and collection surrogate system in Internet on-line sales.

2. Description of the Related Arts

In recent years, a variety of products (or merchandise) are sold through the Internet on-line sales (i.e. sold by mail order via the Internet).

For example, there is a case that an individual shop conducts such sales by setting up or opening a home page on the Internet. Or, there is another case that products of respective shops are advertised on a home page set up by a management company in which a plurality of shops participate. In each case, in general, a customer makes an order individually to each shop, and each shop delivers products individually in response to the order.

However, people working at existing shops which are real physical shops to sell products, need special knowledge about the Internet, such as knowledge about how to create or make a home page and the like, to conduct the Internet on-line sales. Also, in case of direct deal with general customers in remote areas or places, some labor and time is required to deliver those products to them ; in addition, collection of payments is insecure. Therefore, entry into business relating to Internet on-line sales is not easy to the existing shops which are actual shops selling products, particularly, to small-scale shops.

On the other hand, when a customer purchases products from a plurality of shops, he/she needs to pay postage, or delivery cost, thereof to each shop. Since the number of shops opening their shops on the Internet is still small, it is impossible on the Internet to browse all the shops which actually exist, for example, in a shopping center in a specific area.

### SUMMARY OF THE INVENTION

Accordingly, it is an object of the present invention to provide a distribution and collection surrogate system in Internet on-line sales which enables any existing small-scale shop to easily enter into the Internet on-line sales business.

In order to achieve the above object, according to an aspect of the present invention, there is provided a distribution and collection surrogate system in Internet on-line sales comprising: merchandise information presenting means for presenting information about various pieces of merchandise dealt in by a plurality of shops on the Internet; order receiving means for designating at least one of the shops dealing in at least one of the various pieces thereof and for receiving an order thereof on the Internet for the merchandise whose information is presented by the merchandise information presenting means; order notifying means for notifying information about the order received by the order receiving means to a distribution liaison company dealing with the at least one of the shops designated by the order via a communication line; and document data sending means for sending data to be written in a document required to be sent to an orderer in the name of a management company via a communication line to the distribution liaison company.

In the aforementioned constitution, the management company manages the whole system. The customer can obtain information about merchandise (or products) on the Internet by the merchandise information presenting means and make an order for selected merchandise on the Internet by the order receiving means. Order information is sent to the distribution liaison company by the order notifying means. The distribution liaison company makes an order for the ordered merchandise to the designated shops and receives the merchandise from the shops. The distribution liaison company receives data to be filled in documents (invoice, bill, transfer payment slip and so forth) required to be sent to the orderer by the document data sending means and creates the required documents based on the data. Then, the distribution liaison company sends the documents to the orderer along with the merchandise received from the shops.

According to the above constitution, the orderer makes an order for merchandise to the management company and makes a payment to the management company. A nominal person issuing the documents attached to the received merchandise is the management company. That is, the management company becomes a contact point for sales transactions between the orderer and the shops and collects a payment.

The distribution liaison company exists between the management company and the shops and serves as a contact point for transactions with the shops. That is, a shop delivers merchandise to the distribution liaison company in response to an order from the distribution liaison company and receives a payment from the distribution liaison company. Although the shop sells merchandise through the Internet, the merchandise and the payment can be handed over to and from the distribution liaison company according to conventional business practices.

Therefore, existing small-scale shops can easily enter Internet on-line sales business.

In addition, when merchandise of a plurality of shops are contained in one order, postage paid by the orderer is reduced as compared with the case of making an order individually to each shop since the distribution liaison company delivers the merchandise in one package. Therefore, this system is advantageous when parts of a relatively small amount are purchased from various shops.

Preferably, the merchandise information presenting means presents on the Internet information about a plurality of shops actually existing in the same area. The distribution liaison company locates in one of the same area and a nearby area thereof.

In this case, a plurality of shops existing in the same area, for example, a plurality of shops belonging to a shopping center or a wholesale district open virtual shops on the Internet in a group. Since actual transactions are completed with a distribution liaison company located in the same area or a nearby area thereof familiar to the shops, the plurality of shops belonging to the shopping center or the wholesale district can easily open virtual shops on the Internet in a group. Further, conventionally unseen attractive Internet on-line sales can be achieved by enabling a customer to virtually shop around in a shopping center or a wholesale district existing in a remote area on the Internet.

Preferably, the data sent by the document data sending means is image data.

According to the above constitution, the distribution liaison company can create documents based on the received image data. Since the image data is used, no processing such as rearrangement of data or the like is required in the distribution liaison company. Therefore, there is no possibility of any error occurring upon creation of the documents. No load is imposed on the distribution liaison company even when the document format (layout, size or the like of data) is changed.

Preferably, there are further provided prepayment notifying means for notifying the distribution liaison company via a communication line whether a payment is made in advance with respect to an order notified to the distribution liaison company by the order notifying means and payment notifying means for notifying settlement of the payment to the distribution liaison company via a communication line when the payment has been made in advance to the management company.

According to the above constitution, when the orderer makes a payment in advance, the distribution liaison company is notified to this effect by the prepayment notifying means. Therefore, a phantom order can be made for merchandise to shops and delivery of the products can be held until the payment is settled. Thus, products can be sold by prepayment.

### BRIEF DESCRIPTION OF THE DRAWINGS

This and other objects and features of the present invention will become clear from the following description taken in connection with the preferred embodiment thereof with the reference to the accompanying drawings, in which:

FIG. 1 is a conceptual illustration of the whole system to which a distribution and collection surrogate system in Internet on-line sales according to an embodiment of the present invention applies;

FIG. 2 is a flow chart showing work at a management company;

FIG. 3 is a flow chart following FIG. 2;

FIG. 4 is a flow chart following FIG. 3;

FIG. 5 is a flow chart showing work at a distribution liaison company;

FIG. 6 is a flow chart showing work at a shop;

FIG. 7 is a schematic view of a top page of the whole system shown in FIG. 1;

FIG. 8 is a schematic view of a page, introducing a shop, of the whole system shown in FIG. 1; and

FIG. 9 is a schematic view of a page, showing a list of merchandise, of the whole system shown in FIG. 1.

### DETAILED DESCRIPTION OF THE PREFERRED EMBODIMENT

Before the description of the preferred embodiment of the present invention proceeds, it is to be noted that like or corresponding parts are designated by like reference numerals throughout the accompanying drawings.

A distribution and collection surrogate system in Internet on-line sales according to one embodiment of the invention will be described below with reference to the accompanying drawings.

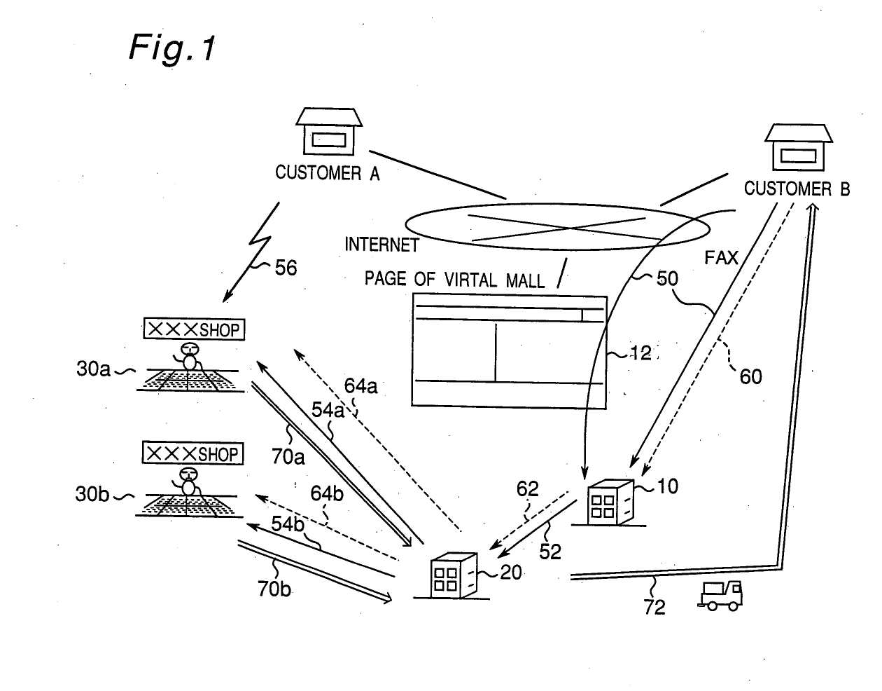

FIG. 1 is a conceptual illustration of a whole system to which the distribution and collection surrogate system in Internet on-line sales applies.

A management company 10 sets up or opens a site on the Internet for a virtual mall in which a plurality of shops 30a, 30b participate. Information about products for sale or the like of the participant shops 30a, 30b is provided through a page 12 of the virtual mall. The participant shops 30a, 30b are, for example, shops located in a specific area (shops in a shopping center or a wholesale district) and form a mall like a consolidation of shops on the net. The system may give an image that products are displayed by individual shops 30a, 30b, checkout is carried out by the management company 10, and the collection and delivery of the products is carried out by a distribution liaison company 20 in this image. The distribution liaison company 20 is located in the shopping center or the like to which the participant shops 30a, 30b belong, or in a nearby area.

For example, when a customer B views the home page 12 of the virtual mall and makes an order for products dealt in by the participant shops 30a, 30b as shown with an arrow 50, the order information is transmitted to the management company 10. The management company 10 transfers the order information to the distribution liaison company 20 as shown with an arrow 52. The distribution liaison company 20 makes orders for the products to the shops 30a, 30b dealing in the products ordered by the customer B, based on the order information as shown with arrows 54a, 54b. The shops 30a, 30b directly deliver the ordered products to the distribution liaison company 20 as shown with arrows 70a, 70b. The distribution liaison company 20 packs all the products ordered by the customer B in one package and delivers the package to the customer B by a home delivery service in the name of the management company 10, as shown with an arrow 70.

Meanwhile, a payment for the products is made by the customer B to the management company 10 as shown with arrow 60. The management company 10 makes a payment to the distribution liaison company 20 under normal business conditions as shown with arrow 62. The distribution liaison company 20 makes payments to the shops 30a, 30b, which delivered the products under normal business conditions as shown with arrows 64a, 64b.

For example, a customer A can directly contact the shop 30a found in the page 12 of the virtual mall, not through the management company 10 as shown with arrow 56.

Roles of the management company 10, the distribution liaison company 20 and the participant shops 30a, 30b in the system will be explained below with reference to the drawings.

The management company 10 is explained first.

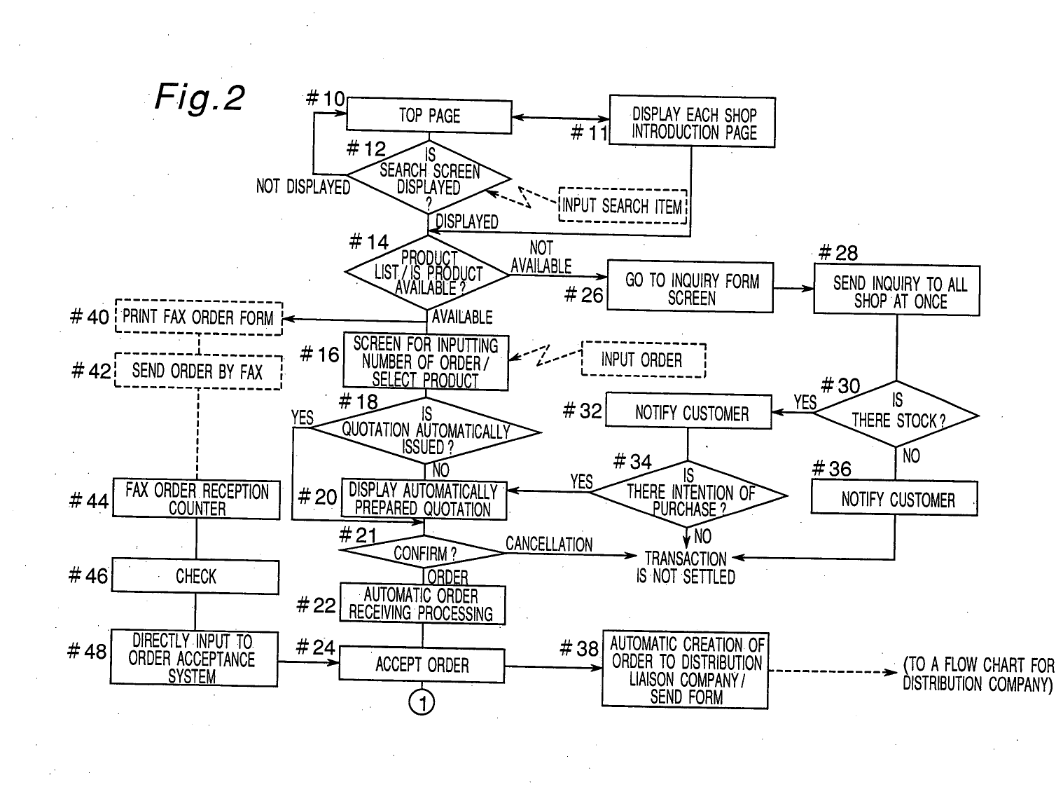

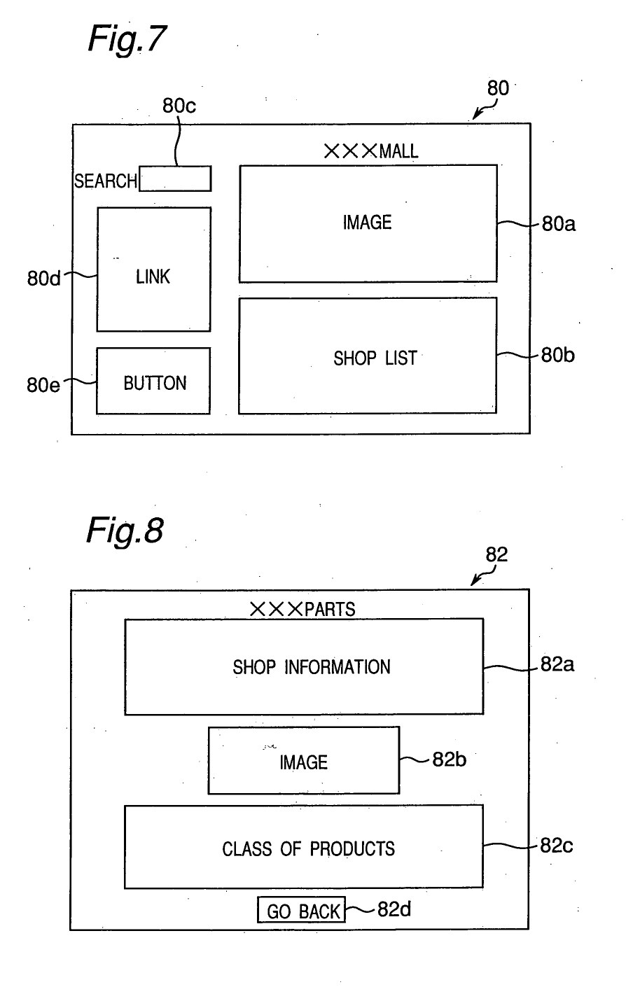

As shown by a flow chart in FIG. 2, a top page of the virtual mall managed by the management company 10 is displayed (#10). For example, an area 80a for displaying an image of the virtual mall, an area 80b for displaying a list of participant shops in the virtual mall, a product search box 80c, an area 80d for displaying buttons of related links and an area 80e for displaying buttons or the like for detailed information, are arranged in the top page 80 as shown in FIG. 7.

When a participant shop listed in the area 80b is selected by clicking its symbol, an introduction page for the shop is displayed (#11). For example, the area 82a for displaying shop information (name, address, telephone number, office hours, name of a shop manager, comments from the manager, advertisement text, name of the shopping center and so forth with respect to the shop), an area 82b for displaying images (for example, photos of product showcases in the actual physical shop and a photo-portrait of the manager), an area 82c for displaying a class of products for sale, an button 82d for returning to the top page and so forth, are displayed on a shop introduction page 82 as shown in FIG. 8.

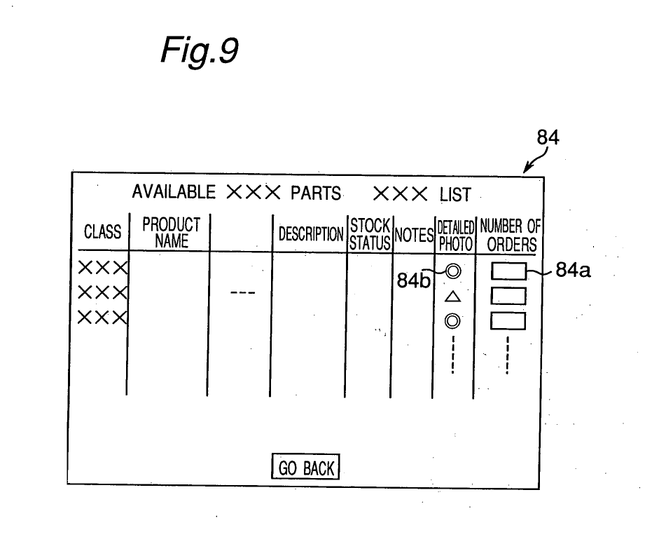

When a desired class is selected and clicked in the area 82c, a detailed information page for products included in the class is displayed. For example, products names, maker names, product numbers, maker product numbers, prices, product description, stock status, notes, availability of detailed photos and the like, are displayed on the detailed information page as shown in FIG. 9. When a symbol 84b indicating that a detailed photo is available is clicked, a photo for the product is displayed. There is also provided a box 84a for inputting the number of orders. The number is added into an order list by inputting the number of orders in the box.

Meanwhile, a desired product can be searched by inputting a product name in the product search box 80c in the top page 80 (#12). When the searched product is available, a product list page is displayed. The product list page is constituted generally similar to the aforementioned detailed information page, but dealer names are additionally displayed. Desired products can be added to the order list from this page.

If the desired product is not available, (“not available” in #14), the customer goes to an inquiry form screen, fills in required items in the form and can send the form to the management company 10 (#26). Upon receipt of the inquiry, the management company 10 makes an inquiry to all the shops by email (or e-mail) or facsimile at once (#28). The management company notifies availability of a stock to the customer depending on the replies from the shops within a predetermined time period (#30, #32, #36). If there is no stock of the product, the transaction is not settled. When there is a stock of the product, the customer's intention of purchase is confirmed (#34). When the customer has an intention of purchase, a quotation is automatically prepared and displayed (#20). If the customer has no intention of purchase, the transaction is not settled.

When the desired products are available (“available” in #14), the customer selects the products and inputs the number of orders (#16). A quotation is prepared as desired and displayed (#18, #20). Then, the order contents and intention of purchase are finally confirmed (#21). If cancellation is made at this stage, the transaction is not settled.

After the order contents and intention of purchase are finally confirmed, the order is received and automatically processed (#22). Thus, acceptance of the order for the products is completed.

Exceptionally, it is possible by an instruction from the customer that image data of a facsimile order form is sent and the customer prints out the facsimile order form by using the customer's own printer (#40). In this case, when the customer fills in required items and sends the form by facsimile (#42), the management company receives the form at a facsimile order reception counter (#44). The contents of compulsory items and availability of a stock of the ordered product(s) are checked (#46). The confirmed order contents are directly inputted by a person in charge (#48). Thus, acceptance of the order for the products is completed (#24).

When the acceptance of the order for the products is completed, order information is automatically transmitted to the distribution liaison company based on the order contents (#38). Consequently, the distribution liaison company carries out the work described later.

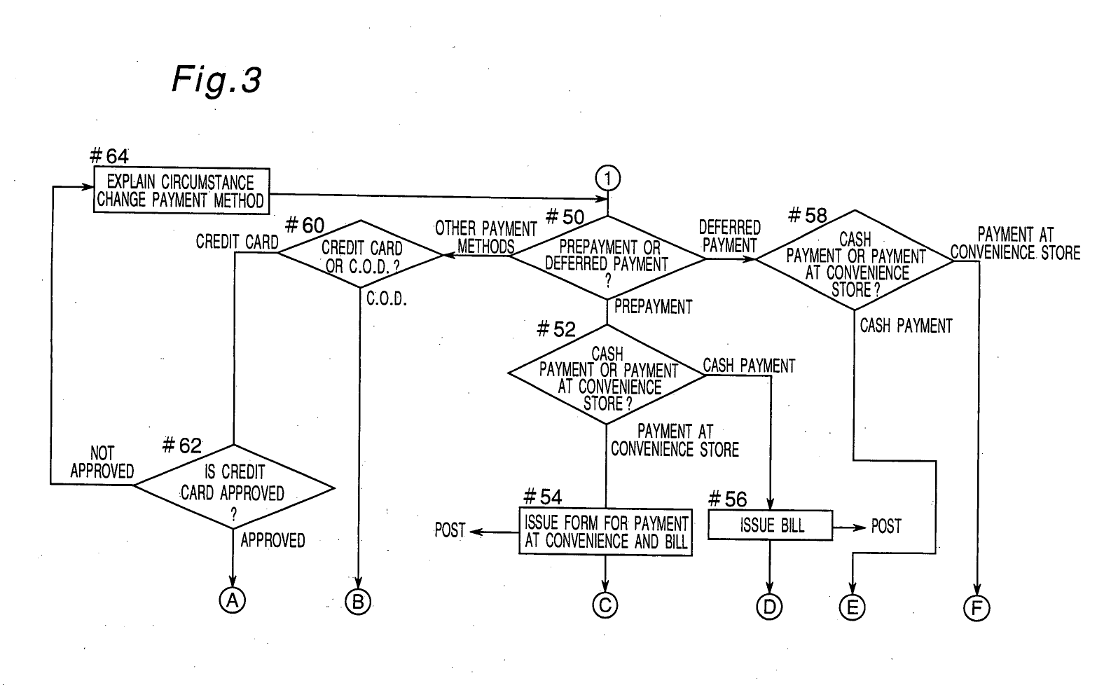

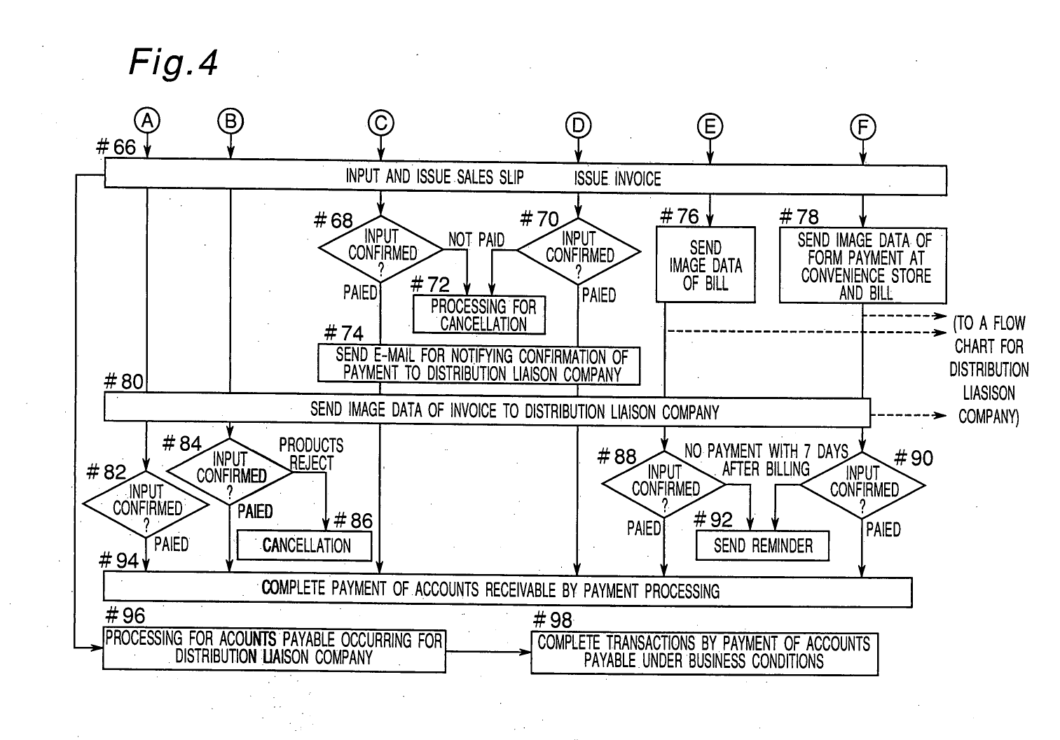

The management company 10 issues a bill and a payment form depending on a payment method selected by the customer. This procedure will be described below with reference to FIGS. 3 and 4.

First, a payment method (i.e. a manner of how to pay the cost or charge of the product(s)) is identified (#50).

In case of prepayment, a cash payment or a payment at a convenience store is selected (#52). In case of the cash payment, a bill is issued and sent to the orderer by post or email (#56). In case of the payment at the convenience store, a form for the payment at the convenience store and a bill are posted (or mailed) to the orderer (#54). Any commercially available package software products, for example, “Konbini Kun” of Mitsui Finance Service Co., Ltd., can be used to create or make a convenience store payment form.

Since accounts receivable occur in the management company by issuing a bill to the orderer, an input processing for issuing a sales slip is performed and image data of an invoice (or a statement of delivery) to the orderer is created or made in the name of the management company (#66). The image data of invoices can be created or made by commercially available software products, for example, DocuWorks of Fuji Xerox.

When the payment by the orderer is confirmed within a predetermined time period (“paid” in #68, #70), an email for notifying confirmation of the payment is sent to the distribution liaison company (#74). The image data of the invoice created at step #66 is compressed and sent to the distribution liaison company (#80). Then, a payment of the accounts receivable is completed by payment processing operation (#94). If the payment is not confirmed within a predetermined time period (“not paid” in #68, #70), a processing operation for canceling the order is carried out (#72).

Meanwhile, a processing operation for accounts payable is performed for the distribution liaison company (#94). A payment of the accounts payable is carried out under business conditions (#98) and the transaction is finished.

In case of payment by a credit card, the credit card is approved (#62). Then, process proceeds to steps #66 and #80. After a payment from a credit card company is confirmed (#82), the payment processing operation is performed (#94). If the credit card cannot be approved for the payment, the customer is given an explanation of the circumstances and asked to change the payment method (#64).

In case of C.O.D. sales (or payment by cash on delivery), process proceeds to steps #66 and #80. After a payment is confirmed (#84), the payment processing operation is performed (#94). If the customer rejects the delivery, a processing operation for canceling the order is carried out (#86).

In case of deferred payment, generally the same processing operation is performed.

In case of cash payment, however, image data of a bill is created, and the image data is sent to the distribution liaison company (#76). In case of payment at a convenience store, image data of a form for payment at the convenience store and of a bill is created, and the image data is sent to the distribution liaison company (#78).

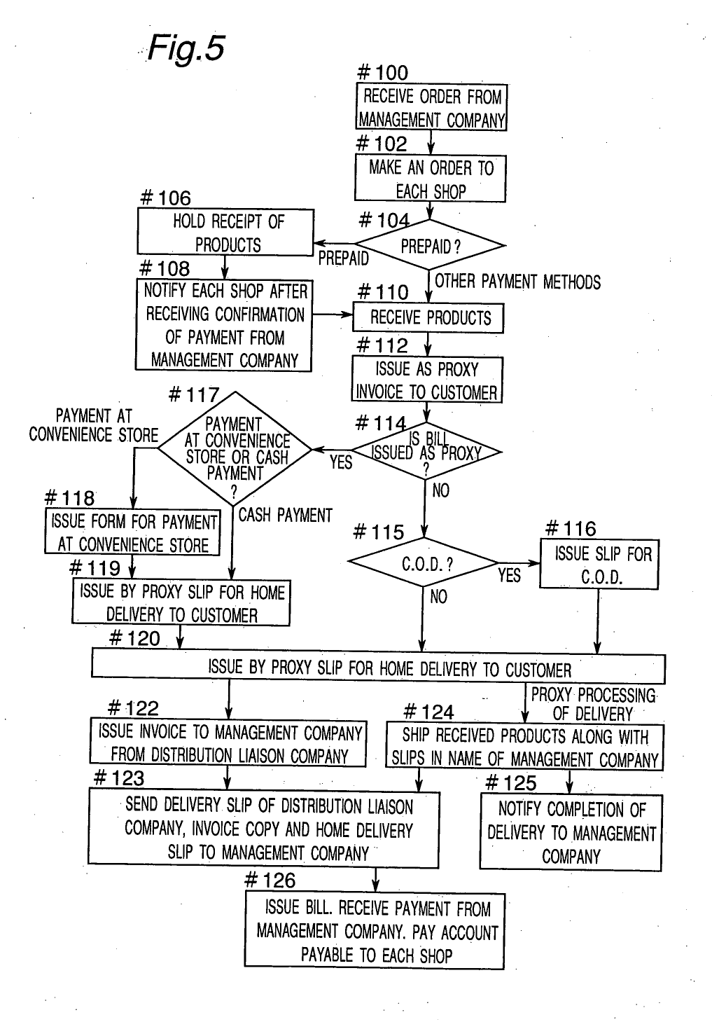

FIG. 5 is a flow chart showing work at the distribution liaison company.

When an order is received from the management company 10 by email (#100), the management company orders products to shops according to the order (#102).

Then a payment condition of the customer is discerned (#104). When the payment condition of the customer is prepayment, receipt of the products is deferred (#106). After an email of confirmation of the payment is received from the management company, the distribution liaison company 20 contacts the respective shops (#108) and then receives the products (#110) therefrom. When the payment condition of the customer is other than prepayment, the distribution liaison company 20 receives the ordered products from the shops without deferring the receipt of the products (#110). Upon the receipt of the products (#110), accounts payable to each shop occur.

Subsequently, the compressed image data of the invoice (or statement of delivery) sent or transmitted from the management company 10 is uncompressed and printed on a designated form. The distribution liaison company issues, as a proxy, an invoice to the customer in the name of the management company (#112).

When a bill and the like are issued by the distribution liaison company as a proxy (“yes” in #114), image data of the bill and the like is compressed and sent from the management company. The image data thereof is then uncompressed and printed on designated forms, and the bill and the like to the customer are issued by the distribution liaison company as the proxy (#117, #118, and #119). In case of C.O.D. sales (or payment by cash on delivery), data sent from the management company is similarly uncompressed, and a C.O.D. payment slip is issued by the distribution liaison company as the proxy (#115, #116).

A home delivery slip (or slip for delivery) to the customer is issued by the distribution liaison company as the proxy, based on the order data from the management company (#120). Then, the slips issued by the distribution liaison company as the proxy are enclosed in the received products and delivered to the customer (#124), and an email notifying completion of delivery is sent to the management company (#125).

Also, an invoice (or statement of delivery) to the management company is issued, and accounts receivable are added or summed up to the management company (#122). The invoice to the management company, a copy of the invoice to the customer in the name of the management company and the home delivery slip to the customer are sent to the management company (#123).

A bill is issued to the management company and a payment is received from the management company. Accounts payable are paid to the shops under predetermined business conditions (#126).

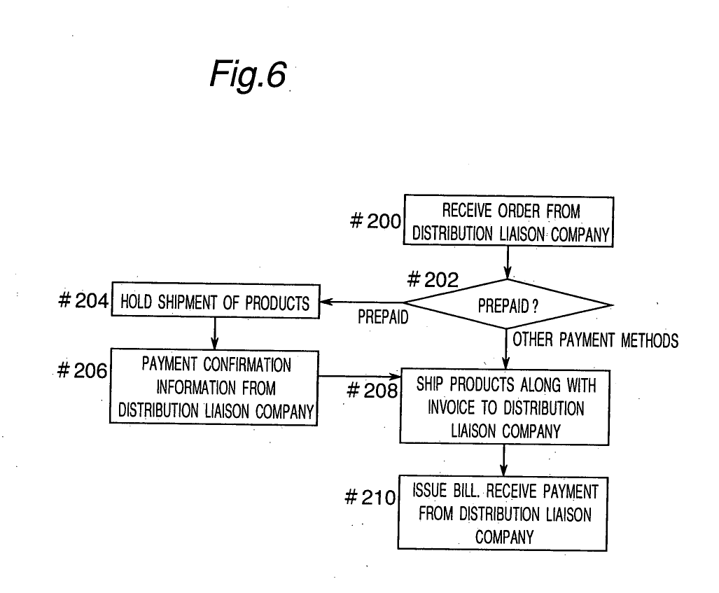

FIG. 6 is a flow chart showing work at the shops.

When an order is received from the distribution liaison company (#200), a payment condition of the customer is discerned (#202). In a case that a payment condition of the customer is prepayment, the product shipment is deferred, or kept on ice (#204). After notification of confirmation of the payment is received from the distribution liaison company (#206), the products are shipped to the distribution liaison company (#208). When the payment condition of the customer is other than the prepayment, the products are shipped to the distribution liaison company without holding (or deferring) the shipment (#208). When the products are shipped, an invoice to the distribution liaison company is attached. After shipment of the products, a bill is issued to the distribution liaison company and a payment is received from the distribution liaison company (#210).

As described above, the shop exchanges products and payments with the distribution liaison company. Since a flow of products and bills based on normal business conditions is achieved between the shops and the distribution liaison company, the shops can deal with the distribution liaison company according to conventional business practices. Creation (or making or opening) of a home page can be commissioned to the management company. Therefore, existing small-scale shops can easily enter Internet on-line sales business.

In addition, since the mall on the net is a consolidation (or group) of actually existing shops, the customer can easily get feeling of reality and familiarity. Since the physical distributions are consolidated, the delivery costs can be minimized and thereby the customer does not feel an increase of costs in case of purchase of products at a small sum.

Although the present invention has been fully described in connection with the preferred embodiment thereof with reference to the accompanying drawings, it is to be noted that various changes and modifications are apparent to those skilled in the art. Such changes and modifications are to be understand as included within the scope of the present invention as defined by the appended claims unless they depart therefrom.

What is claimed is:

1. A distribution and collection surrogate system in Internet on-line sales comprising:
merchandise information presenting means for presenting information about various pieces of merchandise dealt in by a plurality of shops on the Internet;
order receiving means for designating at least one of the shops dealing in at least one of the various pieces thereof and for receiving an order thereof on the Internet for the merchandise whose information is presented by the merchandise information presenting means;
order notifying means for notifying information about the order received by the order receiving means to a distribution liaison company dealing with the at least one of the shops designated by the order via a communication line; and
document data sending means for sending data to be written in a document required to be sent to an orderer in the name of a management company via a communication line to the distribution liaison company.

2. The distribution and collection surrogate system in Internet on-line sales as claimed in claim 1, wherein the merchandise information presenting means presents on the Internet information about a plurality of shops actually existing in the same area, and
wherein the distribution liaison company locates in one of the same area and a nearby area thereof.

3. The distribution and collection surrogate system in Internet on-line sales as claimed in claim 1, wherein the data sent by the document data sending means is image data.
